(19) United States
(12) Patent Application Publication
(10) Pub. No.: US 2007/0058579 A1
(43) Pub. Date: Mar. 15, 2007

(54) Method for processing calls from multiple communication networks and equipment thereof

(75) Inventors: Yibo Xu, Shenzhen (CN); Bibo Liu, Shenhen (CN); Chun He, Shenzhen (CN)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: YULONG Computer Telecommunication Scientific ( Shenzhen) Co., Ltd.

(21) Appl. No.: 11/519,049

(22) Filed: Sep. 12, 2006

(30) Foreign Application Priority Data
Sep. 12, 2005 (CN) 200510099311.9
Feb. 7, 2006 (CN) 200610033527.X

(51) Int. Cl. H04Q 7/00

(52) U.S. Cl. 370/328; 370/401

(57) ABSTRACT

The present invention discloses a method for processing calls from multiple communication networks, comprising: determining if services of a communication network other than the first communication network are already proceeding. If services of the communication network other than the first communication network are already proceeding, terminating the calling request or stopping the proceeding services; otherwise, executing a normal call processing procedure. The present invention also discloses a dual mode mobile terminal, which comprises a first communication module and a corresponding first antenna as well as a second communication module and a corresponding second antenna, and further comprises a first communication module control unit used for controlling functions of the first communication module, a second communication module control unit used for controlling functions of the second communication module and a main control unit used for controlling and scheduling the communication module control units and corresponding communication modules through AT instructions. Adopting the technical solution provided by the present invention can avoid multiple networks from being in the call proceeding state at the same time and greatly decreases the interference among multiple networks.

### FIELD OF THE INVENTION

The present invention relates to mobile communication technologies, more particularly to a method for processing calls from multiple communication networks and equipment thereof.

### BACKGROUND OF THE INVENTION

Nowadays, there are more and more applications of multiple mode terminals, such as a GSM/CDMA dual mode terminal that supports both Global System for Mobile Communications (GSM) and Code Division Multiple Access (CDMA), a GSM/PHS dual mode terminal that supports both GSM and Personal Handset System (PHS), and so on.

According to the existing strategy to process calls of the dual mode terminal, the user can choose a first communication network for communications. When there is a new incoming call from a second communication network, the user can decide whether to answer the new incoming call; if the user chooses to answer the call, the previous call is maintained and the terminal is switched to the new call; otherwise, the new call is rejected.

Inside the dual mode terminal, it is the communication modules corresponding to the communication networks that process the calls. In accordance with the aforesaid call processing method, when answering the new incoming call from the second communication network, the dual mode terminal will send a call hold prompt tone to the communication module that processes the first communication network. Hereby the communication circuit of the first communication network is not released, in other words, the two communication modules are both in an operating state. Since the existing dual mode terminal adopts only one set of power management module, if the two communication modules are both operating simultaneously, electric current capacity of certain devices will be insufficient, and interference will take place between the two communication modules through the shared power management module. There also will be other problems.

Meanwhile, if both the two modules use high powers to transmit signals, there will be a corresponding problem of radio frequency interference. When the circuit of one system adopts a high power to transmit or receive signals, the circuit of the other system will not be able to operate normally because of the interference. Besides, in existing dual mode mobile terminals, the two communication modules are controlled by a shared control unit, which needs to give additional attention to functions like display and input. If the two communication networks operate at the same time, the processing speed will be decreased so that the utilization performance of the terminal will be affected.

### SUMMARY OF THE INVENTION

In view of the above, the present invention provides a method for processing multiple communication network calls as well as a dual mode terminal for implementing the method so that the utilization performance of the dual mode terminal is increased.

The specific technical solution in accordance with the present invention is as follows.

A method for processing calls from multiple communication networks, when a calling request of a first communication network is detected, comprises:

determining if services of a communication network other than the first communication network are already proceeding, if services of the communication network other than the first communication network are already proceeding, terminating the calling request or stopping the proceeding services; otherwise, executing a normal call processing procedure.

Wherein, the first communication network is any one of:

a Global System for Mobile Communication (GSM) communication network, a Code Division Multiple Access (CDMA) communication network, a Personal Handset System (PHS) communication network and a 3^{rd} Generation (3G) communication network; and

the communication network other than the first communication network is any one of:

a GSM communication network, a CDMA communication network, a PHS communication network and a 3G communication network.

Wherein, the calling request is a dial request sent out through the first communication network.

Wherein, the step of determining if services of the communication network other than the first communication network are already proceeding, if services of the communication network other than the first communication network are already proceeding, terminating the calling request or stopping the proceeding services; otherwise, executing the normal call processing procedure comprises:

determining if there is an proceeding call service of the communication network other than the first communication network, if there is the proceeding call service of the communication network other than the first communication network, canceling the current dial request; otherwise

determining if there is an proceeding data service of the communication network other than the first communication network, if there is the proceeding data service of the communication network other than the first communication network, canceling the current dial request; otherwise, dialing according to a normal process.

Wherein, the step of detecting the dial request of the first communication network is: detecting the dial request by determining whether a dial key is pressed.

Wherein, the calling request is a called request received through the first communication network.

Wherein, the step of determining if services of the communication network other than the first communication network are already proceeding, if services of the communication network other than the first communication network are already proceeding, terminating the called request or stopping the proceeding services; otherwise, executing the normal call processing procedure comprises:

determining whether there is an proceeding call service or an proceeding data service in the communication network other than the first communication network, if there is the proceeding call service or the proceeding data service in the communication networks other than the first communication network, accepting or rejecting the called request according to the choice of the user; if the there is neither the proceeding call service nor the proceeding data service, processing the called request in accordance with a normal process.

Wherein, the step of accepting or rejecting the called request according to the choice of the user comprises:

determining whether the user chooses to accept the called request, if the user chooses to accept the called request, terminating the proceeding call service or the proceeding data service; if the user does not choose to accept the called request, determining whether the user directly rejects the called request, if the user choose to directly reject the called request, directly rejecting the called request, if the user makes no choice all the while, automatically rejecting the called request after a period of waiting time.

Wherein, the step of determining whether the user chooses to accept the called request is:

determine whether an answer key is pressed; and

the step of determining whether the user chooses to directly reject the called request is:

determining whether a hang-up key is pressed.

A dual mode mobile terminal, comprises:

a first communication module and a corresponding first antenna;

a second communication module and a corresponding second antenna;

a first communication module control unit, used for controlling functions of the first communication module;

a second communication module control unit, used for controlling functions of the second communication module;

a main control unit, used for controlling and scheduling the communication module control units and the corresponding communication modules through AT instructions.

Wherein, the first communication module further comprises a first power management module and the second communication module further comprises a second power management module.

Wherein, the said first antenna and the second antenna are respectively set at two sides of the dual mode mobile terminal; or

the first antenna and the second antenna are respectively set at the top and the bottom of the dual mode mobile terminal; or

the first antenna and the second antenna are respectively set at the front and the back of the dual mode mobile terminal.

Wherein, the first antenna and/or the second antenna is any one of an external antenna or an internal antenna.

Wherein, the polarization direction of the first antenna and the polarization direction of the second antenna are orthogonal to each other.

Wherein, the first communication module is any one of:

a Global System for Mobile Communication (GSM) communication module, a Code Division (CDMA) communication module, a Personal Handset System (PHS) communication module and a 3^{rd} Generation (3G) communication module;

the second communication module is any one of:

a GSM communication module, a CDMA communication module, a PHS communication module and a 3G communication module.

Wherein, the first communication module control unit is combined with the main control unit;

the combined unit schedules the communication modules by controlling functions of the first communication module directly and controlling the second communication module control unit and the corresponding communication modules through AT instructions.

Wherein, the second communication module control unit is combined with the main control unit;

the combined unit schedules the communication modules by controlling functions of the second communication module directly and controlling the first communication module control unit and the corresponding communication modules through AT instructions.

By adopting the technical solution of the present invention, if there is a call or a data transmission of the dual mode terminal in the first communication network, while receiving a new incoming call from the second communication network, the dual mode terminal will choose between the new call and the original call or between the new call and the original data transmission, rather than maintaining the communications of both the two communication networks at the same time. Thus it is avoided that the two communication modules in the dual mode terminal proceed simultaneously. Meanwhile, due to the separate control unit and the separate power management module as well as the antennas with orthogonal polarization directions, the interference between the two communication modules of the dual mode terminal is minimized, so that the utilization performance of the terminal is improved.

### BRIEF DESCRIPTION OF THE DRAWINGS

FIG. 1 is a flowchart illustrating the active dialing process of the method for processing calls from multiple communication networks in accordance with an embodiment of the present invention;

FIG. 2 is a flowchart illustrating the called process of the method for processing calls from multiple communication networks in accordance with an embodiment of the present invention;

FIG. 3 is a schematic diagram illustrating a dual mode mobile terminal in accordance with a first embodiment of the present invention;

FIG. 4 is a schematic diagram illustrating the dual mode mobile terminal in accordance with a second embodiment of the present invention.

### DETAILED DESCRIPTION OF EMBODIMENTS

In order to make the object, the solution, and the merits of this invention clearer, a further description in detail is hereinafter given to this invention with reference to the accompanying drawings and embodiments.

The present invention discloses a method for processing calls from multiple communication networks in a dual mode terminal. The embodiments of the method will be illustrated hereinafter with reference to an active dialing process and a called process.

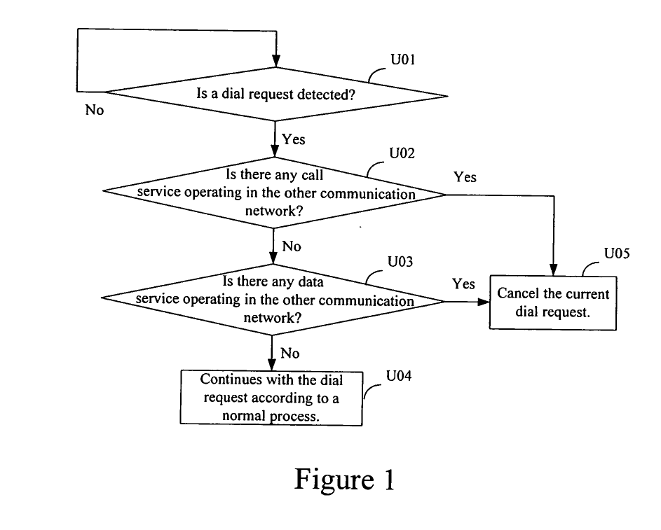

FIG. 1 is a flowchart illustrating the method for processing calls from multiple communication networks in accordance with the embodiment the present invention when the dual mode terminal is actively initiating a dial. The caller, which is also the user, can choose any communication network to initiate a dial actively, herein the dial including a voice dial and a data dial.

Step U01: the dual mode terminal detects whether there is any dial request, if there is a dial request, proceeds to step U02, otherwise continues to execute step U01.

Therein, the procedure of detecting the dial request can be implemented by detecting whether a specific dial key in the terminal is pressed down.

Step U02: according to the dial request detected in step U01, the terminal determines the communication network corresponding to the dial request. The terminal further detects whether there is already any call service proceeding in the other communication network, if there is a call service proceeding in the other communication network, proceeds to step U05, otherwise, continues with step U03.

If there is already a call service proceeding in the other communication network, the dual mode terminal can further indicate that the communication function is busy and that the detected dial in step U01 cannot be continued before breaking the connection of the other communication network. Step U03: the terminal checks if there is any data service proceeding in the other communication network, if there is a data service proceeding in the other communication network, proceeds to step U05, otherwise, continues with step U04.

If there is already a data service proceeding in the other communication network, the dual mode terminal can further indicate that the detected dial in step U01 cannot be continued before breaking the connection of the other communication network.

Step U04: the terminal handles the dial request according to a normal process.

Step U05: the terminal cancels the current dial request.

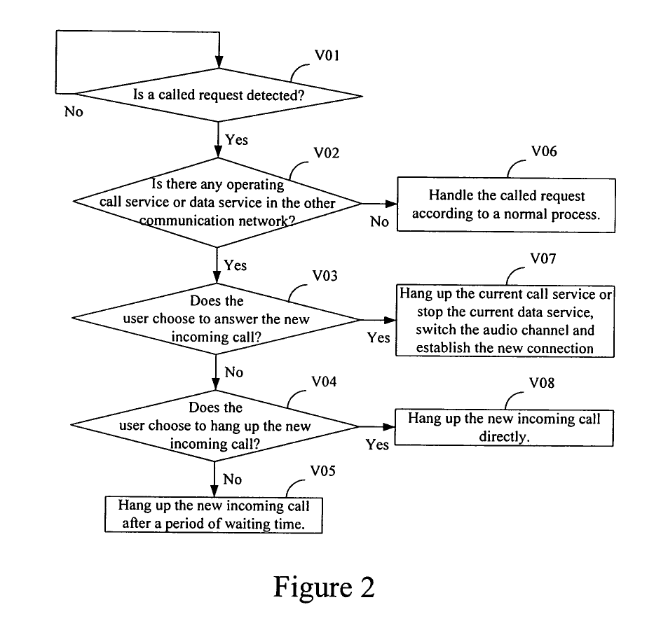

FIG. 2 is a flowchart illustrating the method for processing calls from multiple communication networks in accordance with the embodiment of the present invention when the dual mode terminal is called.

Step V01: the terminal detects whether there is any incoming call, if there is an incoming call, proceeds to step V02, otherwise, continues with step V01. Step V02: according to the incoming call detected in step V01, the terminal determines the communication network corresponding to the incoming call, and determines whether there is already a call service or a data service proceeding in the other communication network. If there is already a call service or a data service proceeding in the other communication network, the terminal sends out an incoming call prompt tone and prompting the user on the interface to choose whether to answer or hang up the new incoming call, and then proceeds to step V03; if there is neither a call service nor a call service in the other communication network, the terminal proceeds to step V06.

Step V03: the terminal determines whether the user chooses to answer the new incoming call. If the user chooses to answer the new incoming call, proceeding to step V07; if the user does not choose to answer the new incoming call, proceeds to step V04. Herein if there is already a data service in the other communication network previously, the previous data service will be continued.

In step V03, the procedure of detecting whether the user chooses to answer the new incoming call can be implemented by detecting whether a specific answer key is pressed down.

Step V04: the terminal determines whether the user directly hangs up the new incoming call; if the user chooses to hang up the new incoming call directly, proceeding to step V08, if the user makes no choice all the time, proceeding to step V05.

In step V04, the procedure of detecting whether the user directly hangs up the new incoming call can be implemented by detecting whether the specific hang-up key in the terminal is pressed down.

Step V05: the dual mode terminal automatically hangs up the new incoming call after waiting for a certain period of waiting time

The period of waiting time is preset.

Step V06: the terminal handles the incoming call according to the normal process.

Step V07: the current call service of the other communication network is hanged up, or the data service of the other communication network is stopped and the network connection is disconnected; and then the audio channel is switched and the audio channel of the communication module corresponding to the new incoming call is connected to a voice effect card and a microphone.

Step V08: the new incoming call is hanged up directly.

As is described above, when applying the method for processing calls from multiple communication networks in accordance with the embodiment of the present invention, the current communication status of the other communication network is detected before both the calling process and the called process so as to prevent the two networks from proceeding simultaneously. Therefore, by adopting the present invention, the function of communicating in multiple networks is realized, while preventing the two or more communication modules from being in the proceeding state at the same time, which will lead to problems such as radio interference and excessive loads of electric current.

In order to implement the aforesaid method for processing calls from multiple communication networks, new modules should be added to the existing dual mode terminal.

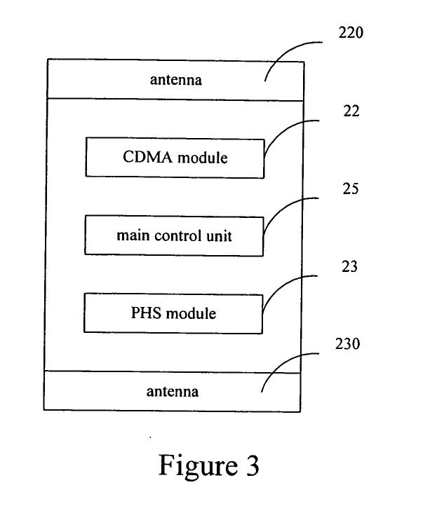

FIG. 3 is a schematic diagram illustrating a dual mode mobile terminal in accordance with a first embodiment of the present invention.

In the embodiment, the dual mode mobile terminal adopts a combination of a CDMA module 22 corresponding to a CDMA communication network and a PHS module 23 corresponding to a PHS communication network, and a main control unit 25 takes charge of the control of the CDMA module 22 and the PHS module 23.

CDMA module 22 and PHS module 23 are respectively connected to an antenna 220 and an antenna 230, which are located at two sides of the dual mode mobile terminal. Therein, the main control unit 25 is used to schedule the CDMA module 22 and the PHS module 23.

Especially, in this embodiment, the antenna 220 is set on the top of the main board while the antenna 230 is set at the bottom of the main board, or the antenna 220 is set at the front of the main board while the antenna 230 is set at the back of the main board, so that the two antennae 220 and 230 is apart form each other for a certain distance, which can enhance the frequency band isolation and make the other systems interference-proof from an proceeding system.

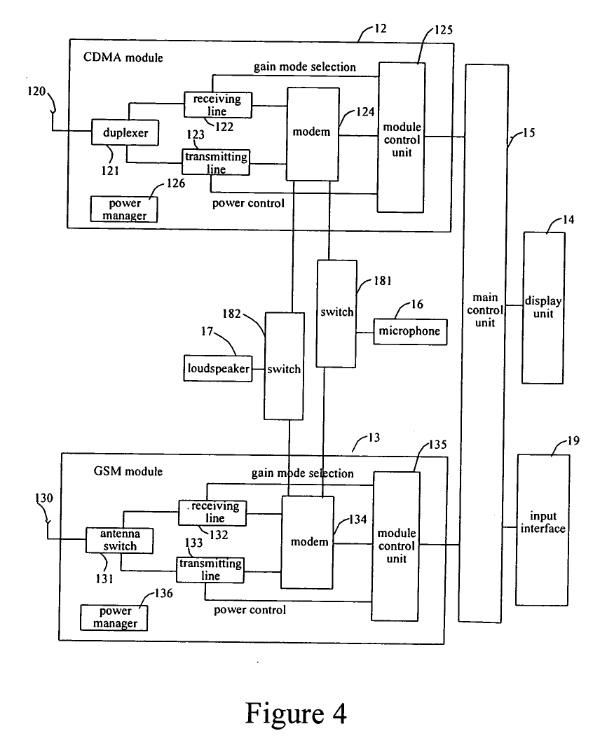

FIG. 4 is a schematic diagram illustrating a dual mode mobile terminal in accordance with a second embodiment of the present invention.

In this embodiment, the dual mode mobile terminal comprises a CDMA module 12 corresponding to a CDMA communication network and a GSM module 13 corresponding to a GSM communication network. Module control units 125 and 135 are respectively set in the CDMA module 12 and the GSM module 13, the module control units 125 and 135 respectively take charge of controlling the CDMA module 12 and the GSM module 13. Besides, the CDMA module 12 and GSM module 13 share peripheral equipment like a display unit 14, a microphone 16, a loudspeaker 17, an input interface 19 and so on.

The CDMA module 12 comprises a duplexer 121, a receiver 122, a transmitter 123 and a modem 124. The GSM module 13 comprises an antenna switch 131, a receiver 132, a transmitter 133 and a modem 134. In the embodiment, existing mature communication modules corresponding to the communication networks are preferably adopted. The communication modules are completely independent from one another and have their respective shields so that the interference among components of the two modules is very weak. Moreover, the communication modules are connected to the main board in form of socket connectors so that the communication modules and the main board are strictly separated, which makes it convenient for maintenance and update.

The CDMA module 12 and the GSM module 13 utilize respectively an antenna 120 and an antenna 130, which are respectively set at two sides of the dual mode mobile terminal, e.g. top and bottom of the dual mode mobile terminal or front and back of the dual mode mobile terminal. Besides, the polarization direction of the antenna 120 and the antenna 130 are orthogonal. For instance, the antenna 120 adopts a horizontal polarization and the antenna 130 adopts a vertical polarization; or the antenna 120 adopts a vertical polarization and the antenna 130 adopts a horizontal polarization. Since the horizontal polarized antenna can only receive or transmit horizontal polarized wave while the vertical polarized antenna can only receive or transmit vertical polarized wave, there is no interference among signals received or transmitted by the antennae with polarization directions orthogonal to each other, thus the frequency band isolation is implemented and the communication is normally performed. Therefore, the CDMA module 12 and the GSM module 13 can operate at the same time efficiently without the interference between each other.

In the same way, the antenna 120 and the antenna 130 can be isolated by adopting a ±45° polarization, namely one antenna adopts a +45° polarization and the other antenna adopts a −45° polarization, there is also the polarization isolation between the two antennae.

When the antenna 120 or the antenna 130 receives a call from the communication network, the module control unit 125 or the module control unit 135. notifies the user about the call. If the user chooses to answer the received call, the module control unit 125 or the module control unit 135 sends a microphone control signal and a loudspeaker control signal to a switch 181 and a switch 182, connects the modem of the corresponding communication module to the microphone 16 and the loudspeaker 17, so that the call can be implemented normally.

For example, when the GSM module 13 is in the communication state and the CDMA module 12 receives the call request, the operation process of each module processing the calls from multiple networks will be illustrated hereinafter. When the GSM module 13 is in the communication state, if the CDMA module 12 receives the call request, the module control unit 125 can notify the user of the call request by way of voice prompt, vibration, interface prompt and so on so that the user can choose to terminate the call or cancel the call through the input interface.

If the user chooses to terminal the call, the module control unit 135 controls the GSM module 13 to send a call terminate message to the GSM network to terminate the call of the current network. And then the module control unit 135 controls the switch 181 and the switch 182 to connect the microphone 16 and the loudspeaker 17 to the modem 124 of the CDMA module 12; and the CDMA module 12 establishes the communication connection between the dual mode terminal and the CDMA network.

If the user chooses to cancel the call, the module control unit 125 controls the CDMA module 12 to send a call establish failure message to the CDMA network and continues with the current communication.

In the embodiment, the main control unit 15 takes charge of scheduling the module control unit 125 of the CDMA module 12 and the module control unit 135 of the GSM module 13 as well as processing display, keyboard input and other function applications. It should be noted that the main control unit 15 will send AT instructions to the module control units 125 and 135 rather than directly send control signals to the GSM module 13 or the CDMA module 12, so that the module control units 125 and 135 can send control signals to the GSM module 13 and the CDMA module 12 respectively and perform power control. By utilizing of the three control units to function harmoniously it can expedite the response performance of the dual mode mobile terminal.

Alternatively, the main control unit 15 can be combined with anyone of the CDMA module control unit 125 and the GSM module control unit 135. If the main control unit 15 is combined with the CDMA module control unit 125, the main control unit 15 directly sends control signals to the CDMA module 12; the main control unit 15 also sends AT instructions to the GSM module control unit 135 so that the GSM module control units 135 can send control signals to the GSM module 13. If the main control unit 15 is combined with the GSM module control unit 135, the main control unit 15 directly sends control signals to the GSM module 13; the main control unit 15 also sends AT instructions to the CDMA module control unit 125 so that the CDMA module control units 125 can send control signals to the CDMA module 12.

In addition, the power management modules 126 and 136 are respectively set in the CDMA module 12 and the GSM module 13 additionally. Adopting the separate power management modules can avoid the problem of the insufficient electric current capacity as well as the problem of the interference between the CDMA module 12 and the GSM module 13 caused by the shared power management module.

The Antennae 120 and 130 can be either the external antennae or the internal antennae.

The present invention is described exemplarily in detain as above with reference to the combination of the GSM communication network and the CDMA communication network as well as with reference to the combination of the CDMA communication network and the PHS communication network. However, those skilled in the art should understand that the present invention is also applicable for the dual mode mobile terminal or the multi-mode mobile terminal in any combination of the GSM communication network, the CDMA communication network, the PHS communication network, the 3G communication network and so on, e.g. the mobile terminal in a combination of dual GSM, of in a combination of GSM and PHS, or in a combination of GSM and 3G, etc. Besides, the present invention is also applicable for the dual mode mobile terminal or the multi-mode mobile terminal that has other circuit structures.

To sum up, the above description is only preferred embodiments of the invention and is not used to limit the protection scope thereof.

1. A method for processing calls from multiple communication networks, when a calling request of a first communication network is detected, comprising:
determining if services of a communication network other than the first communication network are already proceeding, if services of the communication network other than the first communication network are already proceeding, terminating the calling request or stopping the proceeding services; otherwise, executing a normal call processing procedure.

2. The method according to claim 1, wherein, the first communication network is any one of:
a Global System for Mobile Communication (GSM) communication network, a Code Division Multiple Access (CDMA) communication network, a Personal Handset System (PHS) communication network and a 3^{rd} Generation (3G) communication network; and
the communication network other than the first communication network is any one of:
a GSM communication network, a CDMA communication network, a PHS communication network and a 3G communication network.

3. The method according to claim 1, wherein, the calling request is a dial request sent out through the first communication network.

4. The method according to claim 3, wherein, the step of determining if services of the communication network other than the first communication network are already proceeding, if services of the communication network other than the first communication network are already proceeding, terminating the calling request or stopping the proceeding services; otherwise, executing the normal call processing procedure comprises:
determining if there is an proceeding call service of the communication network other than the first communication network, if there is the proceeding call service of the communication network other than the first communication network, canceling the current dial request; otherwise
determining if there is an proceeding data service of the communication network other than the first communication network, if there is the proceeding data service of the communication network other than the first communication network, canceling the current dial request; otherwise, dialing according to a normal process.

5. The method according to claim 3, wherein, the step of detecting the dial request of the first communication network is:
detecting the dial request by determine whether a dial key is pressed.

6. The method according to claim 1, wherein, the calling request is a called request received through the first communication network.

7. The method according to claim 6, wherein, the step of determining if services of the communication network other than the first communication network are already proceeding, if services of the communication network other than the first communication network are already proceeding, terminating the called request or stopping the proceeding services; otherwise, executing the normal call processing procedure comprises:
determining whether there is an proceeding call service or an proceeding data service in the communication network other than the first communication network, if there is the proceeding call service or the proceeding data service in the communication networks other than the first communication network, accepting or rejecting the called request according to the choice of the user; if the there is neither the proceeding call service nor the proceeding data service, processing the called request in accordance with a normal process.

8. The method according to claim 7, wherein, the step of accepting or rejecting the called request according to the choice of the user comprises:
determining whether the user chooses to accept the called request, if the user chooses to accept the called request, terminating the proceeding call service or the proceeding data service; if the user does not choose to accept the called request, determining whether the user directly rejects the called request, if the user chooses to directly reject the called request, directly rejecting the called request, if the user makes no choice all the while, automatically rejecting the called request after a period of waiting time.

9. The method according to claim 8, wherein, the step of determining whether the user choose to accept the called request is:
determine whether an answer key is pressed; and
the step of determining whether the user chooses to directly reject the called request is:
determining whether a hang-up key is pressed.

10. A dual mode mobile terminal, comprising:
a first communication module and a corresponding first antenna;
a second communication module and a corresponding second antenna;
a first communication module control unit, used for controlling functions of the first communication module;
a second communication module control unit, used for controlling functions of the second communication module;
a main control unit, used for controlling and scheduling the communication module control units and the corresponding communication modules through AT instructions.

11. The dual mode mobile terminal according to claim 10, wherein, the first communication module further comprises a first power management module and the second communication module further comprises a second power management module.

12. The dual mode mobile terminal according to claim 10, wherein, the said first antenna and the second antenna are respectively set at two sides of the dual mode mobile terminal; or
the first antenna and the second antenna are respectively set at the top and the bottom of the dual mode mobile terminal; or
the first antenna and the second antenna are respectively set at the front and the back of the dual mode mobile terminal.

13. The dual mode mobile terminal according to claim 10, wherein, the first antenna and/or the second antenna is any one of an external antenna or an internal antenna.

14. The dual mode mobile terminal according to claim 10, wherein, the polarization direction of the first antenna and the polarization direction of the second antenna are orthogonal to each other.

15. The dual mode mobile terminal according to claim 10, wherein, the first communication module is any one of:
a Global System for Mobile Communication (GSM) communication module, a Code Division (CDMA) communication module, a Personal Handset System (PHS) communication module and a 3^{rd} Generation (3G) communication module;
the second communication module is any one of:
a GSM communication module, a CDMA communication module, a PHS communication module and a 3G communication module.

16. The dual mode mobile terminal according to claim 10, wherein, the first communication module control unit is combined with the main control unit;
the combined unit schedules the communication modules by controlling functions of the first communication module directly and controlling the second communication module control unit and the corresponding communication modules through AT instructions.

17. The dual mode mobile terminal according to claim 10, wherein, the second communication module control unit is combined with the main control unit;
the combined unit schedules the communication modules by controlling functions of the second communication module directly and controlling the first communication module control unit and the corresponding communication modules through AT instructions.
